(19) United States
(12) Patent Application Publication
(10) Pub. No.: US 2003/0102681 A1
(43) Pub. Date: Jun. 5, 2003

(54) High speed pickhead

(76) Inventor: Gary Bouchard, Santa Cruz, CA (US)

Correspondence Address: BEYER WEAVER & THOMAS LLP, P.O. BOX 778, BERKELEY, CA, 94704-0778, US

(21) Appl. No.: 10/226,630

(22) Filed: Aug. 22, 2002

Related U.S. Application Data
(60) Provisional application No. 60/337,206, filed on Dec. 4, 2001.

(51) Int. Cl. B25J 15/06

(52) U.S. Cl. 294/64.1

(57) ABSTRACT

A pickhead apparatus capable of picking and placing integrated circuits is disclosed. The pickhead apparatus includes a drive bar assembly having one or more drive bars that move in a linear manner. The pickhead apparatus also includes a motor assembly including a first servomotor and a second servomotor. The pickhead apparatus further includes a cam assembly operatively coupled to and between the drive bar and motor assemblies. The cam assembly includes a cam arrangement that is actuated by the first servomotor so as to select a particular drive bar of the drive bar assembly, and a drive frame that is actuated by the second servomotor so as to drive the particular drive bar when selected by the cam arrangement.

### CROSS REFERENCE TO RELATED APPLICATION

This application claims the priority of U.S. Provisional Patent Application No.: 60/337,206, (Attorney Docket No.: ICONP005P), entitled “High Speed Pickhead”, filed on Dec. 4, 2001 and which is incorporated herein by reference.

This application is related to U.S. patent application Ser. No.: ______, (Attorney Docket No.: ICONP004), entitled “Integrated Processing System”, filed on even date and which is incorporated herein by reference.

### FIELD OF THE INVENTION

The invention generally relates to integrated circuit processing equipment. More particularly, the invention relates to a high speed pick head for picking and placing integrated circuits.

### BACKGROUND OF THE INVENTION

In brief, chip scale packages refer to a packaging technology that allows an integrated circuit to be attached to a printed circuit board face-down, with the chip's pads connecting to the PC board's pads through individual balls of solder. During fabrication thereof, multiple integrated circuit chips (ball grid arrays and dies) are formed on a single substrate (e.g., circuit board), and thereafter separated into a plurality of individual or single integrated circuit chips.

The separation procedure is sometimes referred to as singulation. Singulation takes many forms including sawing (or dicing), stamping, water jet cutting and laser singulation. With regards to sawing, the substrate is generally held on a chuck while one or more saw blades cut through the substrate to form a plurality of individual integrated circuit chips.

After singulation, post processing steps are generally performed. During these steps, the chips are typically transported through various process regions, as for example, buffering, cleaning (e.g., wash and dry), testing (e.g., electrical), inspecting (e.g., vision), packaging and the like. Conventionally, the chips are transported via pick and place machines, nests, tape and reel and the like. Pick and place machines are typically used to output the chips into output trays (e.g., good or rejects). In most cases, the pick and place machines pick up a part in one position and place the part in another position. Although pick and place machines are mainly used to place chips in output trays, they may also be used to transport chips between stations (e.g., they may be used throughout a process or they may be used only at the end).

Pick and places machines generally include a motor transfer unit and a pickhead assembly that cooperate to transport a chip. The motor transfer unit provides horizontal motion to move the pickhead assembly from one location to another location and the pickhead assembly provides vertical motion to pick and place the part. The vertical motion is typically linear in one direction while the horizontal motion may be linear, rotary and the like, in multiple directions.

In most cases, the pickhead assembly uses a linear actuator (e.g., a pneumatic cylinder or electrical actuator) to drive a moving member up and down so as to allow a gripper to pick or place (release) the chip. The gripper is typically a suction cup that provides a suction force capable of holding onto the chip during transportation thereof. Furthermore, the moving member typically moves in a linear direction to and from an initial position (retracted) and a pick or place position (extended). When in the pick or place position, the pickhead assembly can either pick up a chip for transport or place an chip at a desired location, for example onto output trays. A typical sequence may include: moving the pickhead assembly to a desired position via the motor driven transfer unit; extending the moving member via the linear actuator; picking up a chip via the gripper; retracting the moving member via the linear actuator while maintaining a grip on the chip; moving the pickhead assembly to a new desired location via the motor driven transfer unit; retracting the moving member via the linear actuator; and placing the chip by releasing the chip from the gripper.

The pickhead assembly may include several moving members/grippers. In cases such these, the moving members are generally actuated together or sequentially. When actuated together, each of the moving members moves at the same time. When actuated sequentially the moving members move at different times, but generally follow one another in succession (e.g., sequence). For example, if the pickhead assembly includes 4 moving member/grippers generally numbered 1-4, then moving member 1 moves first, moving member 2 moves second, moving member 3 moves third and moving member 4 moves fourth. A typical pick sequence may include pick a first chip with moving member 1, step the pickhead assembly (to a new position via the motor transfer unit), pick a second chip with moving member 2, step the pickhead assembly, pick a third chip with moving member 3, step the pickhead assembly, pick a fourth chip with moving member 4, step the pickhead assembly for placing the picked chips. A typical place sequence may include place the first chip with moving member 1, step the pickhead assembly (to a new position via the motor transfer unit), place the second chip with moving member 2, step the pickhead assembly, place the third chip with moving member 3, step the pickhead assembly, place the fourth chip with moving member 4.

Unfortunately, conventional pickhead assemblies such as those just described have several drawbacks. One drawback with conventional pickhead assemblies is that they provide no control with regards to the position, velocity, and acceleration of the moving member. Conventional pickhead assemblies generally have moving members that only stop at two positions (e.g., retracted and extended). They cannot stop between these positions. Furthermore, the moving members generally move at a single speed. The speed is generally slower than desired in order to ensure the proper picking and placing of parts as well as to prevent damage thereto. If the pick device moves too quickly at the pick point (beginning of its rise), then the gripper may not pick up the part. Furthermore, high speeds at the pick or place point may damage or misalign parts. It is generally desirable to pick or place parts slowly at the pick or place point so as to reduce wear and tear and to ensure proper picking and placing. Unfortunately, however, this increases the cycle time of the machine, which thereby reduces throughput (e.g., 8000 units per hour).

Another drawback of conventional pickhead assemblies is that each moving member requires a separate linear actuator. This adds cost and complexity to the pickhead assembly. Another drawback of conventional pickhead assemblies is that they are not fully integrated, i.e., they do not integrate vacuum valves, vacuum sensing, high speed communications, analog digital controller, and other mechanical and electrical features that would result in a fully integrated unit.

In view of the foregoing, it would be desirable to provide an improved pickhead assembly.

### SUMMARY OF THE INVENTION

The invention relates, in one embodiment, to a pickhead apparatus capable of randomly picking or placing a plurality of integrated circuits in any order.

The invention relates, in another embodiment, to a pickhead apparatus capable of converting rotary motion into linear motion so as move a drive bar having a pick device attached thereto.

The invention relates, in another embodiment, to a pickhead apparatus capable of driving a plurality of pickheads with a single driving source, the pickheads being configured to pick and place integrated circuits.

The invention relates, in another embodiment, to a pickhead apparatus having a plurality of pickheads for picking and placing discrete parts. Each of the pickheads includes a drive bar and a pick device. The drive bar is configured to move in a linear manner. The pick device is configured to grip or release a discrete part. The p pickhead apparatus includes a single actuator capable of providing motion for moving the plurality of drive bars. The pickhead apparatus also includes a drive mechanism configured to transmit the motion of the single actuator to a selected drive bar of the plurality of drive bars so as to move the selected drive bar along a linear path.

The invention relates, in another embodiment, to a pickhead assembly having a plurality of pickheads for picking and placing parts. The pickhead assembly includes a cam assembly capable of moving so as to select a particular pickhead and to drive the particular pickhead along a linear path. The pickhead assembly also includes an actuator assembly operatively coupled to the cam assembly, the actuator assembly being configured to control the movement of the cam assembly so as to select and drive the particular pickhead.

The invention relates, in another embodiment, to a pickhead apparatus capable of picking and placing integrated circuits. The apparatus includes a drive bar assembly including one or more drive bars that move in a linear manner. The apparatus also includes a motor assembly including a first servomotor and a second servomotor. The apparatus further includes a cam assembly operatively coupled to and between the drive bar and motor assemblies. The cam assembly includes a cam arrangement that is actuated by the first servomotor so as to select a particular drive bar of the drive bar assembly, and a drive frame that is actuated by the second servomotor so as to drive the particular drive bar when selected by the cam arrangement.

The invention relates, in another embodiment, to a pickhead apparatus capable of picking and placing integrated circuits. The apparatus includes a drive bar assembly including one or more drive bars that move in a linear manner. Each of the drive bars has a pick device attached thereto. Each of the pick devices is configured to grip or release an integrated circuit. The apparatus also includes a movement assembly for moving the one or more drive bars between a retracted position and an extended position. The extended position places the pick device in a position to grip or release an integrated circuit. The apparatus further includes a manifold assembly that integrates a plurality of control components associated with controlling the movement assembly and the pick devices. The manifold assembly includes at least a circuit board having communication and analog to digital conversion capabilities.

The invention relates, in another embodiment, to a pickhead apparatus having one or more drive bars that move in a linear manner. Each of the drives bars has one or more pick devices attached thereto. The pickhead apparatus includes a dual concentric servomotor having first and second drive shafts that are concentrically positioned and that rotate about the same axis. The pickhead apparatus also includes a drive assembly including a cam shaft that moves relative to and that is concentrically located within a drive frame. The cam shaft is coupled to the first drive shaft and the drive frame is coupled to the second drive shaft such that they both rotate about the same axis. The cam shaft has one or more cam plates that correspond to the one or more drive bars. The drive frame has one or more rocker levers that pivot relative to the drive frame. Each of the rocker levers is operatively coupled to individual ones of the drive bars and individual ones of the cam plates. Each of the rocker levers includes a cam follower capable of engaging a corresponding cam plate and a drive pin capable of engaging a corresponding drive bar. The cam follower is configured to transmit the motion of the cam shaft to the rocker lever so as to secure the drive pin to the drive bar. The secured drive pin is configured to transmit the rotary motion of the drive frame to the drive bar so as to move the drive bar in the linear manner.

The invention relates, in another embodiment, to a method of picking or placing parts with a plurality of pickheads. The motion of each of the pickheads is controlled by a single source. The method includes selecting one of the pickheads. The method also includes controlling the linear movement of the selected pickhead with the single source. The method further includes selecting another one of the pickheads. The method additionally includes controlling the linear movement of the second selected pickhead with the single source.

### BRIEF DESCRIPTION OF THE DRAWINGS

The invention may best be understood by reference to the following description taken in conjunction with the accompanying drawings in which:

FIG. 1 is a perspective diagram of a high speed pickhead, in accordance with one embodiment of the present invention.

FIG. 2 is a broken away perspective diagram of the high speedpick head, in accordance with one embodiment of the present invention.

FIG. 3 is a broken away perspective diagram of the cam assembly, in accordance with one embodiment of the present invention.

FIG. 4 is a broken away perspective diagram of an individual bearing module of the drive bar assembly, in accordance with one embodiment of the present invention.

FIG. 5 is a broken away perspective diagram of the manifold assembly, in accordance with one embodiment of the present invention.

FIGS. 6A-6C are broken away perspective diagrams showing the operation (rotary to linear conversion) of the cam assembly relative to the drive bar assembly, in accordance with one embodiment of the present invention.

FIG. 7 is a block diagram of an integrated circuit processing system, in accordance with one embodiment of the present invention.

FIG. 8 is a block diagram of a manifold assembly, in accordance with one embodiment of the present invention.

FIG. 9 is a simplified diagram of an integrated circuit processing system, in accordance with one embodiment of the present invention.

### DETAILED DESCRIPTION OF THE INVENTION

The invention generally pertains to a pick and place machine capable of conveying parts in a processing system regardless of the methods used to process the parts. More particularly, the invention pertains to a pickhead assembly capable of picking and placing the parts. The pickhead assembly described herein is particularly suitable for picking and placing individual integrated circuits in integrated circuit processing equipment or systems. By way of example, the integrated circuits may be in the form of individual dies, unpackaged chips, packaged chips (e.g., surface mount devices), and the like.

One aspect of the invention relates to pickhead assembly that utilizes actuators to select and/or drive a plurality of pickheads (e.g., pick device and drive bar) for picking and placing parts. In one embodiment, the actuators are servomotors. Another aspect of the invention relates to a cam indexing mechanism that cooperates with an actuator to help select the individual pickheads. Another aspect of the invention relates to a rotary to linear drive mechanism that cooperates with an actuator to help drive the selected pickheads. In one embodiment, a first actuator is used along with the cam indexing mechanism to select individual pickheads and a second actuator is used along with the rotary to linear drive mechanism to drive the pickheads along a linear path, i.e., a separate actuator drives each mechanism. In one implementation, the first and second servomotors are combined into a single unit. Another aspect of the invention relates to a pickhead assembly that is highly integrated. For example, the pickhead assembly may contain components such as high performance valves and analog differential pressure transducers that provide quick vacuum pull down times. The pickhead assembly may also contain components such as analog to digital conversion and communication systems that provide easy interfacing to the controller of the pick and place machine.

In one embodiment, the pickhead assembly is a compact and integrated electromechanical device that picks and places integrated circuits (e.g., surface mount device such as chip scale packages) at high speeds. For example, the pickhead assembly may be capable of picking or placing at a rate of about 20,000 to 40,000 units per hour, and more particularly of about 30,000 units per hour. It should be noted, however, that this is not a limitation since the speed is scalable to the number of pick devices and drive bars used in the pickhead assembly. To elaborate, the actuators of the pickhead assembly correspond to a pair of high performance servomotors. One of the servomotors is configured to drive the pickheads via the rotary to linear drive mechanism and the other is configured to select the pickheads via the cam indexing mechanism. In one implementation, the servomotors are contained in one housing, and provide 2 concentric shafts at one end of the mechanism. Because a high performance servomotor drives the pick head, it can move each with programmable position, velocity, and acceleration control any where along the pickhead's stroke. For example, because a high performance servomotor selects the pickhead, each of the pickheads can be selected randomly, as well as sequentially. Furthermore, the servomotor may enable the pickhead to move slow at the ends of the stroke and fast in the middle of the stroke so as to pick and place parts at greater speeds than otherwise achieved with conventional devices.

That is, the speed profile (e.g., speed vs. stroke) of the pickheads (e.g., ascent or descent) may be varied according to the specific needs of the system in which the pickhead assembly is positioned. For instance, the descent—ascent profile may be symmetrical or asymmetrical. In symmetrical profiles, the initial descent or ascent as well as the final descent or ascent may be similar. For example, the initial descent may be rapid and the final descent may be rapid. In asymmetrical profiles, the initial descent or ascent and the final descent or ascent (or anywhere therebetween) may be different. For example, the initial descent may be rapid, and the final descent may be slow or gentle. This may be necessary when picking or placing fragile or thin devices, which may be cracked or destroyed if the ascending/descending acceleration is to rapid. Similarly, the initial ascent may be slow or gentle, and the final ascent may be rapid. This may be necessary when picking or placing larger more massive devices, which may be pulled off the pick device if ascending/descending acceleration is to rapid. Furthermore, the descent and ascent profiles for each pick device may be similar or different. For example, some pick devices may be descended slowly in their final descent and thereafter ascended slowly in their initial ascent. And some pick devices may be descended slowly in their final descent and thereafter ascended rapidly in their initial ascent.

Although servomotors are generally preferred (e.g., sustainable high speed, acceleration, rapid response time, etc.), it should be noted that they are not a limitation and that other types of actuators may also be used. For example, torquers, stepper motors, voice coil actuators, and the like may be used. Limited angle torquers may also be used for rotary to linear driving (a form of servo system).

To elaborate further, the cam indexing mechanism includes a central camshaft that has a plurality of cam plates (e.g., eight), each of which is used to select an individual pickhead (e.g., drive bar). Each cam plate has a lobe spaced a predetermined number of degrees from it neighbor. In one implementation, at one point in the rotation of the camshaft all the cam plates share a position where there is no lobe on any cam plate. This serves as neutral where all the pickheads are mechanically disengaged (allows for servicing). In one particular embodiment, the cam indexing mechanism includes eight cam plates that are spaced at 40 degree increments. In addition, all the cam plates share the 9^{th} 40-degree position where there is no lobe on any cam plate. As should be appreciated, one of the servomotors drives the camshaft under program control.

Moreover, the rotary to linear drive mechanism includes a drive frame that surround the camshaft in a concentric manner. The drive frame carries a plurality of drive levers, cam followers, and drive pins (e.g., eight of each). A cam follower and drive pin is secured to each drive lever. Each cam follower follows its associated cam plate, and when located on a lobe, causes a lever to pivot and engage the drive pin into a slot in the selected drive bar. At this point, the drive frame and cam shaft rotate together up to 30 degrees causing the downward travel of the drive bar. The drive frame carries the drive pin along a nearly linear path, and the camshaft follows to prevent the cam follower from the rolling off the cam lobe. The direction is reversed to drive the drive bar upward. In most cases, each of the drive bars rides on a linear bearing. As should be appreciated, the second servomotor drives the drive frame under program control.

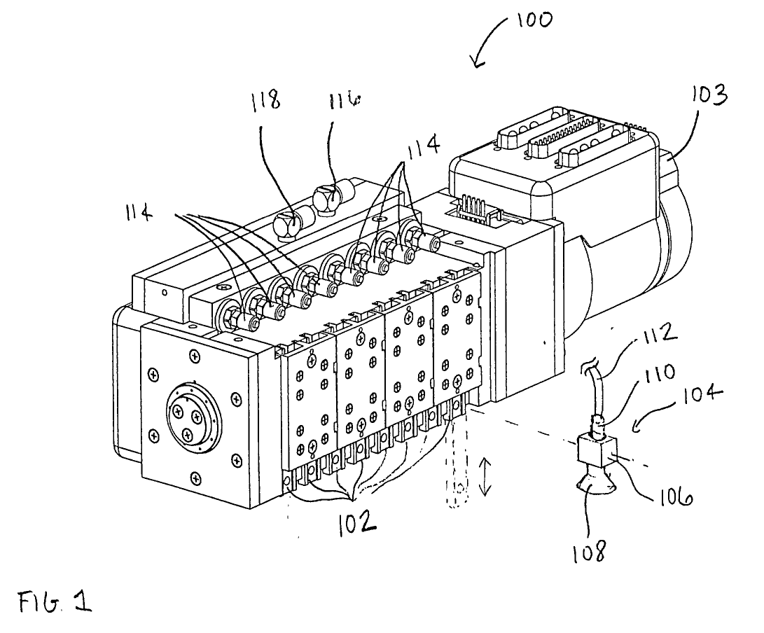

Embodiments of the invention are discussed below with reference to FIGS. 1-9. However, those skilled in the art will readily appreciate that the detailed description given herein with respect to these figures is for explanatory purposes as the invention extends beyond these limited embodiments. For ease of explanation, the below description refers to a pickhead assembly that moves individual integrated circuits such as chip scale packages. It should be noted, however, that the invention is applicable to all devices described herein.

FIG. 1 is a perspective diagram of a high speed pickhead 100, in accordance with one embodiment of the present invention. The high speed pickhead 100 includes a plurality of drive bars 102, each of which is capable of moving a pick device 104 along a precise linear path. The drive bars 102 are configured to move in a linear direction between a rest position (as shown) and a pick up or release position (shown by the dotted lines). When in the pick-up or release position, the pick device 104 can either pick up an integrated circuit or release an integrated circuit. In one embodiment, the drive bars are driven by a motor 103.

Although only one pick device 104 is shown, it should be noted that there is generally one pick device 104 for each drive bar 102. The pick device 104 includes a bracket 106 that attaches to the drive bar 102. By way of example, the pick device 104 may be attached to the drive bar 102 via a screw or bolt (not shown). The bracket 106 is configured to support a first fitting (not shown) for receiving a suction cup 108 and a second fitting 110 for receiving an air hose 112. The suction cup 108 is the device that actually engages the integrated circuit. The first and second fittings are fluidly coupled together. The air hose of each of the pick devices 104 is configured to be coupled to a corresponding fitting on the high speed pickhead 100. For example, in the embodiment shown, the air hose 112 is typically coupled to the corresponding fitting 114, i.e., the corresponding fitting is configured to receive the opposite end of the air hose. Each of the corresponding fittings 114 are fluidly coupled to a vacuum coupling 116 for coupling to a vacuum source and a purge coupling 118 for coupling to an air blowing source. When a vacuum is supplied to the vacuum coupling 116, the suction cup 108 is capable of attaching an integrated circuit thereto. When pressurized air is supplied to the purge coupling 118, the integrated circuit is blown off of the suction cup 108. This is generally done to overcome sticktion at the interface of the suction cup and the integrated circuit. Although not shown, the bracket 104 may also include a small orifice for balancing the vacuum pressure between the plurality of pick devices 104, i.e., it evacuates the volume of air contained in the line while maintaining a desired vacuum pressure.

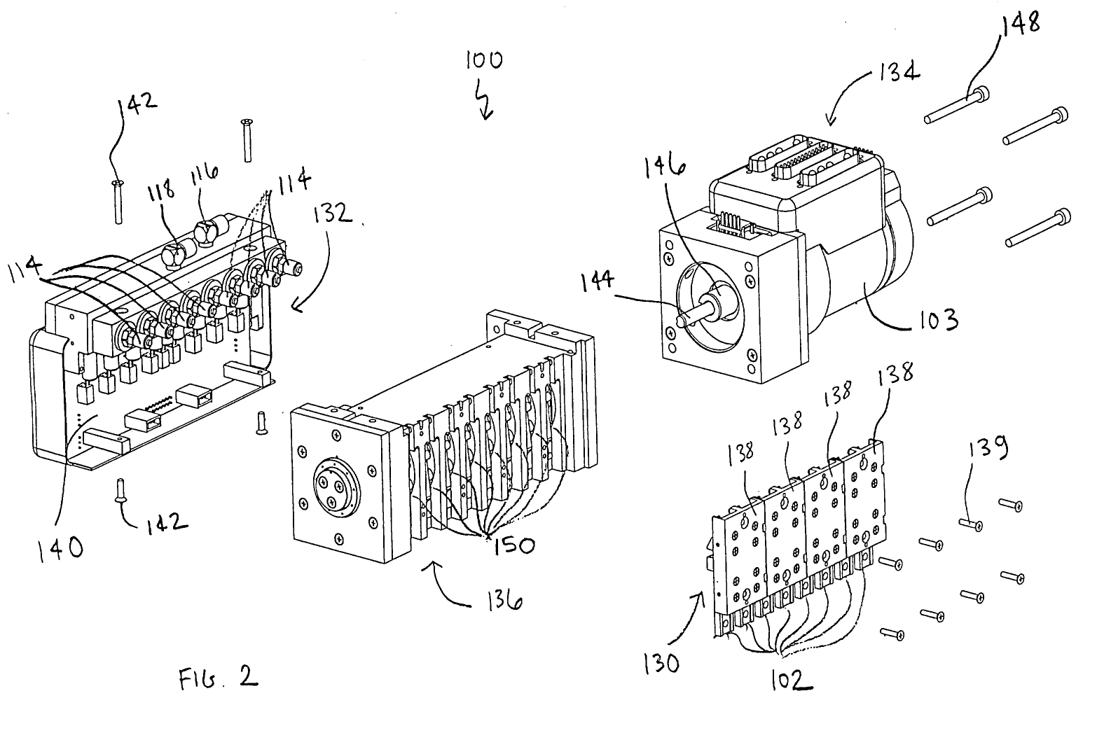

FIG. 2 is a broken away perspective diagram of the high speed pick head 100, in accordance with one embodiment of the present invention. The high speed pickhead 100 is a highly integrated pickhead that contains various subassemblies. As shown, the high speed pickhead 100 includes a drive bar assembly 130, a manifold assembly 132, a motor assembly 134 and a cam assembly 136, all of which cooperate to form a single unit. The drive bar assembly 130 includes one or more bearing modules 138. Each of the bearing modules 138 contains one or more drive bars 102. The bearing modules 138 provide a bearing surface or linear bearing for allowing linear movements of the drive bars 102. Each of the bearing modules 138 is configured to be mounted to the cam assembly 136. By way of example, the bearing modules may be mounted to the cam assembly via screws or bolts 139.

The manifold assembly 132 includes the control components 140 of the high speed pickhead 100. For example, the manifold may provide a plurality of inputs and outputs associated with air, electronics and communications. As shown, the manifold assembly 132 also includes the plurality of corresponding fittings 114, vacuum coupling 116 and purge coupling 118. The manifold assembly is configured to be mounted to the cam assembly 136. By way of example, the manifold assembly 132 may be mounted to the cam assembly 136 via screws or bolts 142.

The motor assembly 134 includes the one or more motors 103. In one embodiment, the one or more motors 103 represents two motors. The two motors may be widely varied. In one embodiment, the two motors are servo motors. Servo motors provide total control of speed, velocity and position. With regards to position, encoders used in the servo motors enable the servo motors to stop at almost any point. In another embodiment, the two motors are disposed inside the same housing. In the illustrated embodiment, the one or more motors 103 correspond to a dual concentric servo motor. Dual concentric servo motors generally include two servo motors in one housing. The concentric nature of the motor means that the motor assembly 134 includes a first drive shaft 144 and a second drive shaft 146 that are concentrically positioned. In the embodiment shown, the first drive shaft 144 is positioned inside the second drive shaft 146. One of the drive shafts is configured to control the selection of the drive bar to be actuated, and the other drive shaft is configured to drive the drive bar to be actuated between its initial and pick-up or release position. The motor assembly 134 is configured to be mounted to the cam assembly 136. By way of example, the motor assembly 134 may be mounted to the cam assembly 136 via screws or bolts 148. The motor assembly 134 also includes one or more connectors 149 through which power and communications are supplied to the motor assembly 134. Motor components used to make a motor of this type are readily available, as for example, from Kollmorgen of Radnich, Va.

The cam assembly 136 includes a cam arrangement (not shown) capable of selecting one or more rocker drive levers 150. In most cases, each of the one or more rocker drive levers 150 corresponds to an individual one of the one or more drive bars 102. The rocker drive levers 150 are generally configured to actuate its corresponding drive bar when selected by the cam arrangement. The cam assembly also includes a drive frame (not shown) capable of driving the drive bar when the drive bar is actuated by the corresponding rocker drive lever 150. In one embodiment, one of the drive shafts 144, 146 is coupled to the cam arrangement for movement thereof and the other drive shaft 144, 146 is coupled to the drive frame for movement thereof.

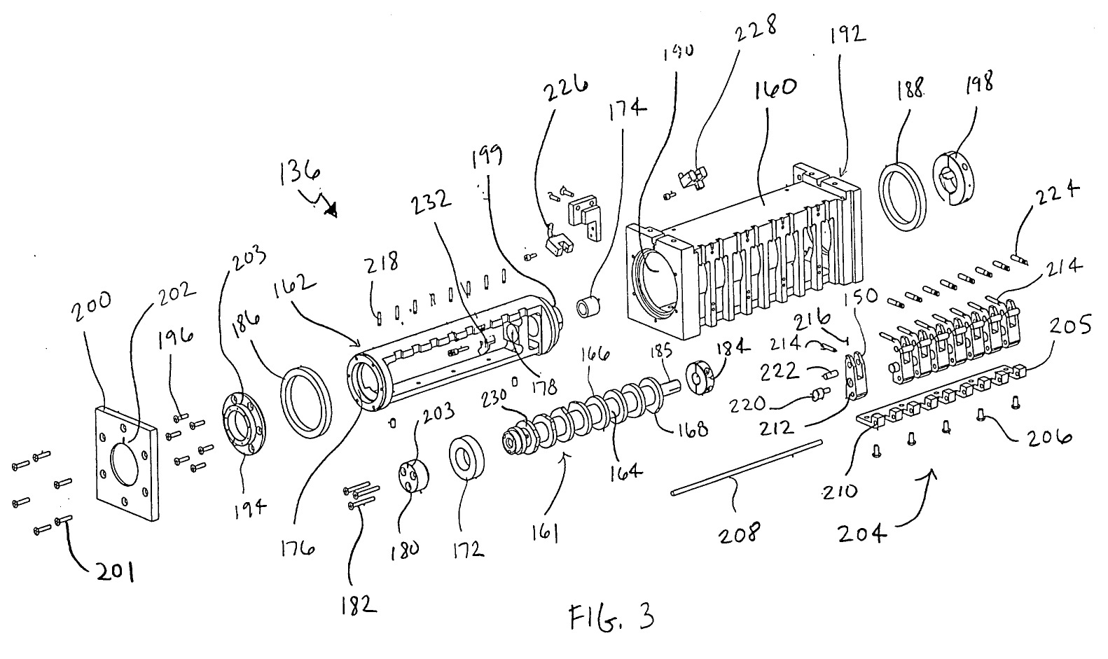

FIG. 3 is a broken away perspective diagram of the cam assembly 136, in accordance with one embodiment of the present invention. The cam assembly 136 includes a main housing 160 to which the other assemblies are mounted. The main housing 160 is configured to surround and protect the internal components of the cam assembly 136. The cam assembly 136 also includes a cam shaft 161 and a drive frame 162, both of which are contained inside the housing 160 in its final assembled form. The cam shaft 161 selects the desired drive bar 102 and the drive frame 162 actuates the linear motion of the selected drive bar 102.

The cam shaft 161 includes a shaft 164 and a plurality of spaced apart cam plates 166. Each of the cam plates 166 includes a lobe 168 (high point on the plate). The number of plates may be widely varied. In most cases, the number of plates corresponds to the number of drive bars. In the illustrated embodiment, there are 8 cam plates. The position of the cam plates on the shaft may also be widely varied. However, the position is generally determined dividing 360 degrees by the number of desired cam plates. If a neutral position is desired, then the number of neutral positions desired is added to the number of desired cam plates before dividing. As should be appreciated, neutral positions represent areas where all of the cam plates are disengaged and thus servicing may be performed. In the illustrated embodiment, there is one neutral position and eight cam plates and thus each of the cam plates is positioned at a different 40 degree interval (e.g., 0, 40, 80, 120 . . . ). The interval may follow a sequence or be random. In the illustrated embodiment, the interval is sequenced. For example, the first cam plate is positioned at 40 degrees and each cam plate thereafter adds a 40 degree rotation (e.g., 40, 80, 120, 160, 200, 240, 380, 320)

The cam shaft 161 is configured to be disposed inside the drive frame 162. In the illustrated embodiment, the cam shaft 161 is concentrically located within the drive frame 162. The cam shaft 161 is also configured to move (rotate) relative to the drive frame 162. In one embodiment bearings are configured to rotatably support the cam shaft inside the drive frame. As shown, the shaft 164 is configured to be disposed inside a first bearing 172 and a second bearing 174, and the first and second bearings 172 and 174 are configured to be disposed in opposite openings 176 and 178 respectively, of the drive frame 162. The first bearing 172 is mounted to the end of the shaft 164 via a bearing clamp 180 and screws 182. The second bearing 174 is secured to the drive frame 162 by press fit or adhesive or other like means, into opening 178

In order to drive the rotation of the cam shaft 161, the cam shaft 161 is configured to be coupled to the first drive shaft 144. This is generally accomplished via a coupling clamp 184 that secures a collet portion 185 of the shaft 164 around the first drive shaft 144.

The drive frame 162 is configured to be disposed inside the main housing 160. The drive frame 162 is also configured to move (rotate) relative to the main housing 160. That is, the drive frame 162 is rotatably positioned inside the main housing 160 via a first bearing 186 and a second bearing 188, which are disposed in opposite openings 190 and 192 respectively, of the main housing 160. The first bearing 186 is mounted to the end of the drive frame 162 via a bearing clamp 194 and screws 196.

In order to drive the rotation of the drive frame 162, the drive frame 162 is configured to be coupled to the second drive shaft 146. This is generally accomplished via a coupling clamp 198 that secures a collet portion 199 of the drive frame 162 around the second drive shaft 146.

The cam assembly 136 also includes a housing end cap 200 for closing one end of the main housing 160. The housing end cap 200 is generally attached to the main housing 160 via screws 201. The housing end cap 200 may provide an alignment assist feature or mark 202 that corresponds to a mark or marks 203 on the bearing clamps 180 and 194. The marks allow an operator to determine the position of the drive frame 162 and cam shaft 161 when the cap assembly 136 is in its assembled condition. For example, if the mark 203 of the cam shaft is rotated 40 degrees from the mark 202 of the housing end cap 200, then the operator may ascertain that the first cam plate 168 of the cam shaft 161 is actuated. These marks may be used for teaching the device.

The cam assembly 136 also includes a rocker drive lever assembly 204. The rocker drive lever assembly 204 includes a rocker pivot mount 205 that mounts directly to the drive frame 162 via screws 206. The rocker drive lever assembly 204 also includes a pivot pin 208 that is configured to be positioned in pivot holes 210 of the rocker pivot mount 205 and the pivot holes 212 of the rocker drive levers 150. This allows the rocker drive levers 150 to pivot relative to the rocker pivot mount 205. Each of the rocker drive levers 150 is held back by a pivot return spring 214 (when it comes forward the spring pulls it back). The pivot return spring 214 is held in place by anchors 216, which are attached to the rocker drive levers 150 and posts 218, which are attached to the drive frame 162. The rocker drive levers 150 are actuated (moved forward) by a cam follower 220 attached thereto, i.e., there is a cam follower for each rocker drive lever 150. The cam follower 220 is configured to engage a corresponding cam plate 166, and more particularly the cam lobes 168 of the cam plates 166. There is also a drive pin 222 for each rocker drive lever 150. The drive pin 222 is the pin that engages grooves in the drive bars 102 in order to drive the drive bars 102 in the linear direction.

The cam assembly 136 also includes one or more anchor posts 224 corresponding to the one or more drive bars 102. The anchor posts 224 provide an anchor for attaching one end of a spring. The other end of the spring is attached to the corresponding drive bar 102. The spring is configured to continually bias the drive bars 102 in their initial position.

Servo motors generally have to have a home position and therefore the cam assembly 136 also includes a first home sensor 226 for sensing the home position of the first motor and a second home sensor 228 for sensing the home position of the second motor. The sensors may be widely varied. In the illustrated embodiment, photo optical switches are used. The first homing sensor 226 is tripped by hole 230 located in the last cam plate 166, and the second homing sensor 228 is tripped by a flag 232.

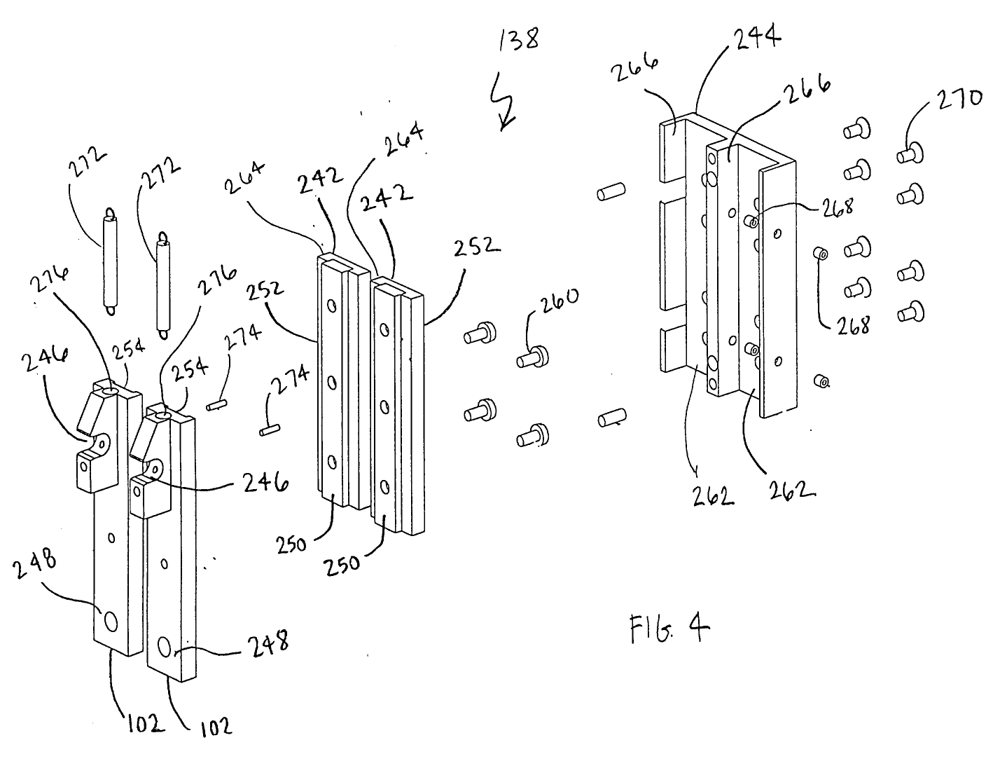

FIG. 4 is a broken away perspective diagram of an individual bearing module 138 of the drive bar assembly 130, in accordance with one embodiment of the present invention. The bearing module 138 includes a pair of drive bars 102, a pair of linear bearings 242, and a bearing mount block 244. Each of the drive bars 102 includes a groove 246. The groove 246 is configured to engage individual ones of the drive pins 222 of the rocker drive levers 150. The drive bars 102 also include a mounting surface 248 for accepting individual ones of the brackets 106 of the pick devices 104. Each of the linear bearings 242 includes a movable portion 250 and a fixed portion 252. The movable portion 250 is configured to be accepted by an individual slot 254 of the drive bar 102. The movable portion 250 is attached to the drive bars 102 via screws 260. The fixed portion 252 generally has clearance holes (not shown) that allow the insertion of the screws 260 through the movable portion 250 and into the drive bars 102.

The fixed portions 252, on the other hand, is configured to be accepted by an individual slot 262 of the bearing mount block 244. In one embodiment, the fixed portion 252 includes a reference surface 264 that abuts a reference surface 266 of the slot 262. Set screws 268 are used to position the fixed portions inside the slots 260, i.e., when tightened, the set screws apply a force that causes the reference surfaces to abut one another. The fixed portion 252 is attached to the bearing mount block 244 via screws 270.

The bearing module 138 also includes a pair of drive bar return springs 272. The drive bar return springs 272 are configured to bias the drive bars 102 in their initial position. One end of the drive bar return springs 272 is connected to the drive bars 102 via dowel pins 274. The other end of the drive bar return spring 272 is connected to the anchor post 224 of the cam assembly 136. In the illustrated embodiment, the drive bar return springs 272 are inserted into openings 276 in the drive bars 102 so as to engage the dowel pin 274.

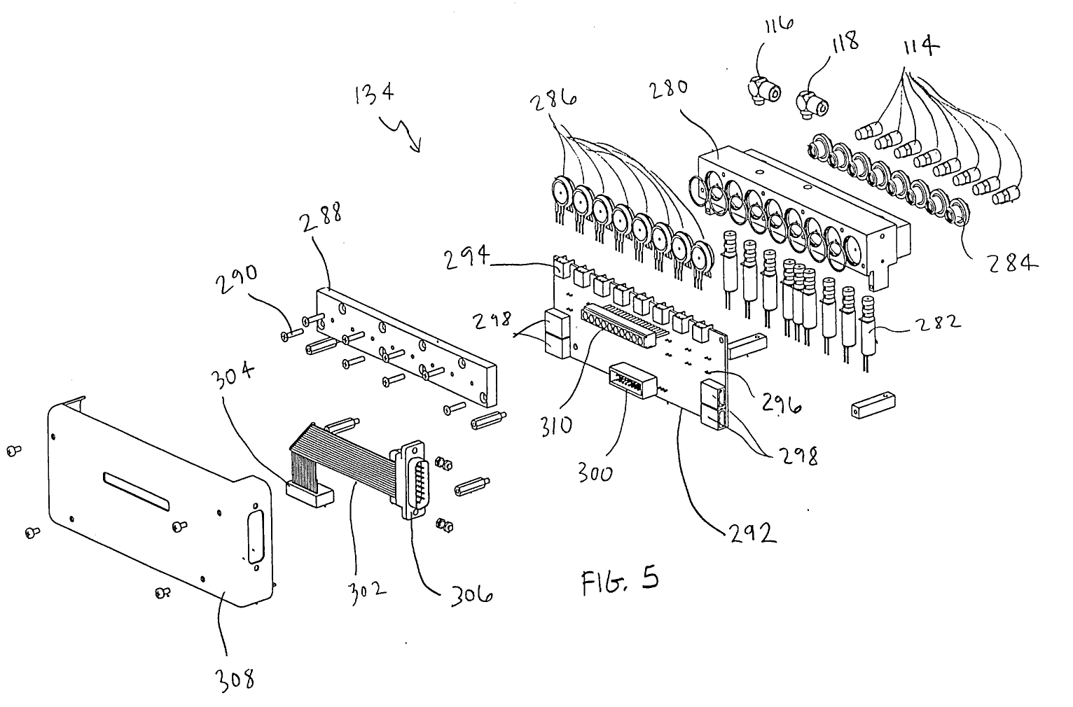

FIG. 5 is a broken away perspective diagram of the manifold assembly 134, in accordance with one embodiment of the present invention. The manifold assembly is a highly integrated device that integrates sensors, valves, A/D conversion and communications, as well as other features therein. The manifold assembly 134 includes a manifold 280. Attached to the manifold 280 are the fittings 114 and couplings 116 and 118. As previously mentioned, each of the fittings 114 is configured to receive an individual air hose for coupling to a pick device and the couplings 116 and 118 are configured to be coupled to vacuum and air sources, respectively. The flow through the fittings and couplings is controlled by a plurality of valves 282. In essence, the valves control vacuum and purge flows to each vacuum pad. There is typically one vacuum valve for each fitting and a single purge valve for all of the fittings. In the illustrated embodiment, the manifold assembly includes eight vacuum valves and one purge valve. The valves 282 are disposed inside the manifold 280. Filter cartridges 284 may be used to provide particle protection to the valves (e.g., filter). A plurality of sensors 286 are also provided for measuring the pressure of the air flow through the valves 282. By way of example, pressure transducers such as analog pressure transducers may be used. The sensors 286 are generally mounted to the manifold 280 via a sensor clamping plate 288 and a plurality of screws 290.

The manifold assembly 280 also includes a circuit board 292. The circuit board 292 is configured to carry the electrical components of the manifold assembly 280. In most cases, the printed circuit board may have various integrated circuits such as processors attached thereto. For example, the functions of the circuit board may be by an onboard controller such as a Motorola 8051 microcontroller core manufactured by Motorola of Schaumburg, Ill. or a Microchip Technology PIC series microcontroller manufactured by Microchip Technology of Chandler, Ariz. (among others). Further, the functions may be enabled by way of an onboard microcontroller program such as those stored in non volatile memory (e.g., EPROM, Flash, etc.)

In one embodiment, the circuit board is an analog to digital conversion circuit board having a high speed communication link. Analog to digital conversion allows the manifold assembly to be controlled via software (e.g., programmable). For example, the analog pressure sensors and analog to digital converter provide program control of the vacuum trip point. In addition, the target points associated with the valves may be set and vacuum detection may be viewed. The high speed communication link may be widely varied. In one implementation, the communication link corresponds to a RS485 communications channel that provides a 900K baud serial communications link to the host controller. In another implementation, the communications link corresponds to ALINK, a proprietary 6-12 Mbit communications and I/O protocol, manufactured by Algo of Japan. Alternatively, universal serial bus (USB), Firewire or the like may be used.

The printed circuit board 292 includes a plurality of connectors. For example, the printed circuit board 292 includes connectors 294 for connection to the sensors 286 and connectors (not shown—disposed on the other side of the board) for connection to the valves 282 (see solder points 296). In one embodiment, the sensors 286 and valves 282 plug directly into their respective connectors to reduce the amount of wiring needed in the system (modular). The circuit board 292 also includes a plurality of auxiliary connectors 298 for allowing additional capacity when needed. The auxiliary connectors 298 may be input or output connectors. The circuit board 292 also includes an output connector 300 for receiving and transmitting data to and from the printed circuit board 292. The output connector 300 may be disposed in the center of the circuit board 292. This allows the printed circuit board 292 to be placed front or back in a pickhead (different pickheads may need different orientations). A transfer cable 302 is typically used to connect the output connector 300 to the outside world. The transfer cable 302 includes a plug 304 for inserting into the output connector 300 and a connector 306, which is mounted in a cover 308 of the manifold assembly 134. The connector 306 allows the manifold assembly to be connected to an electronic control system such as computer system. The computer system may be an embedded or host computer of some sort, such as a PC in all its various forms or a programmable logic controller as are commonly available in the art. The electronic control system may include the software for providing inputs and reading outputs from the manifold assembly. The circuit board 292 also includes an LED array 310, which relays the status of each of the valves and other information such as if power is applied to the assembly.

Although not shown, the printed circuit board may also include connectors for attachment to other sensors and related devices of the entire pickhead. For example, the printed circuit board may include connectors for connection to the home sensors 226 and 228 of the cam assembly 136. The printed circuit board 292 may also include other components such as components used for error checking (e.g., CRC redundancy). Additional digital inputs and outputs may also be provided.

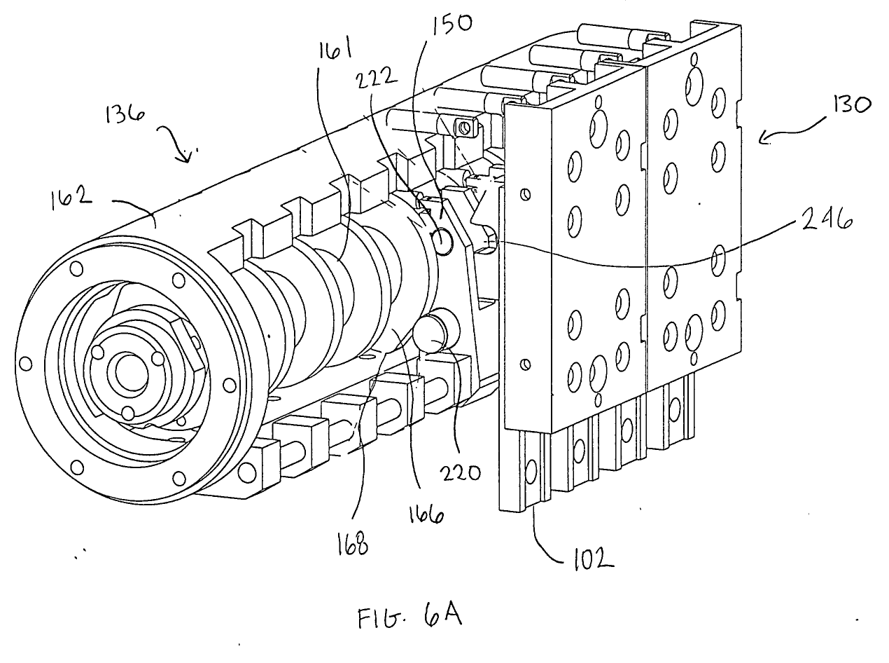

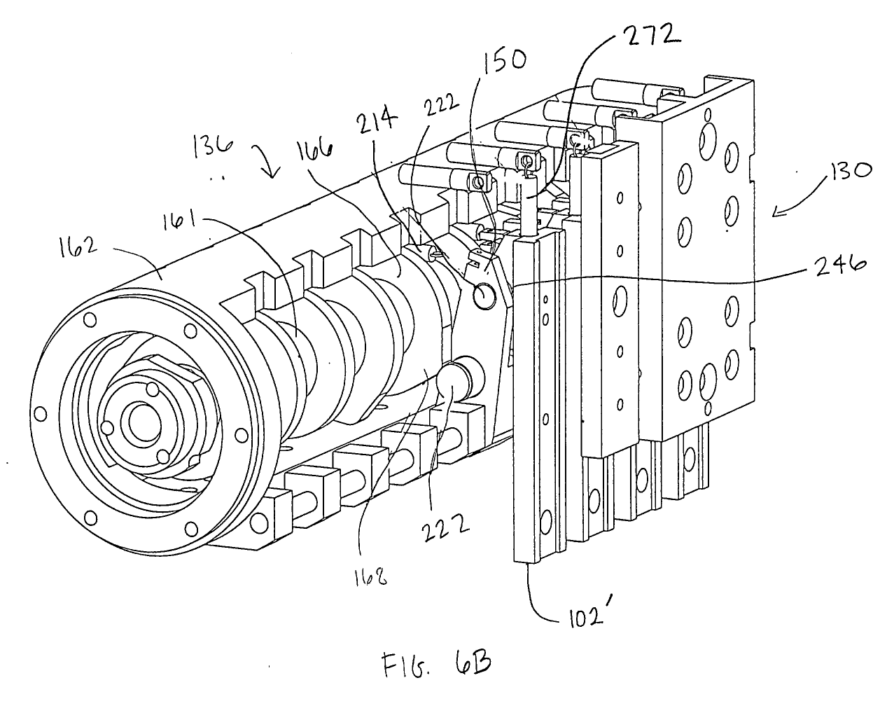

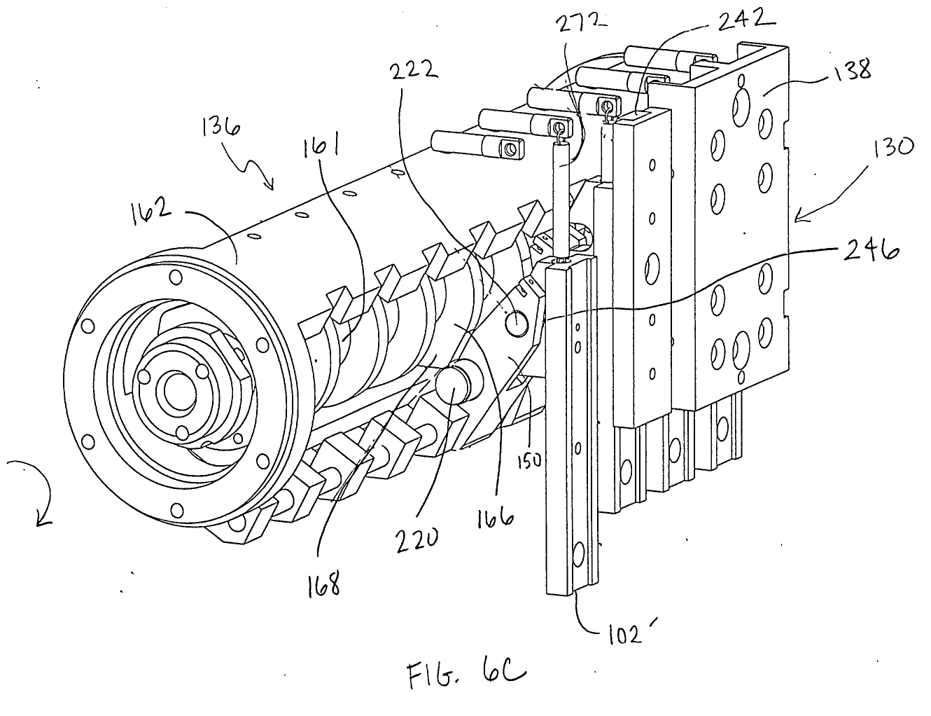

FIGS. 6A-6C are broken away perspective diagrams showing the operation (rotary to linear conversion) of the cam assembly 136 relative to the drive bar assembly 130, in accordance with one embodiment of the present invention. For ease of discussion, only a portion of the drive bar assembly 130 is shown. FIG. 6A illustrates the operation of the cam assembly 136 and drive bar assembly 130 in an initial condition. FIG. 6B illustrates the operation of the cam assembly 136 and drive bar assembly 130 during selection of a particular drive bar 102′ to be actuated. FIG. 6C illustrates the operation of the cam assembly 136 and the drive bar assembly 130 during actuation of the selected drive bar 102′.

FIG. 6A shows the cam assembly 136 and drive bar assembly 130 before each station selection, i.e., none of the drive bars have been selected. This may represent the point in the rotation of the camshaft where all cam plates share the 9^{th} 40-degree position. During this sequence, the drive frame 162 is positioned at 0 degrees or top dead center. In addition, the cam shaft 161 is in position to index so as to position a desired lobe 168 of a desired cam plate 166 against its corresponding cam follower 220 of the rocker drive lever 150. The cam follower 220 is waiting to transmit the motion of the cam shaft 161 to the rocker drive lever 150. In most cases, the rotary motion of the cam shaft 161 is turned into a pivoting action of the rocker drive lever 150. The drive pin 222 of the rocker drive lever 150, in turn, is waiting to engage the groove 246 of the drive bar 102 and to transmit the rotary motion of the drive frame 162 to the linearly guided drive bar 102.

As shown in FIG. 6B, the cam shaft 161 indexes via the first motor of the motor assembly thereby positioning the lobe 168 of the cam plate 166 against the cam follower 222 of the rocker drive lever 150. By way of example, the cam shaft may index at 40 degree intervals to position the various lobes 168 against its corresponding cam follower 222. In the illustrated embodiment, the cam shaft 161 is indexed 160 degrees so as to position the fourth lobe against the fourth cam follower of the fourth drive bar. The rotary action of the lobe 168 against the cam follower 222 causes the rocker drive lever 150 to pivot towards the drive bar 102. By way of example, the rocker drive lever 150 may pivot 14 degrees. The pivoting action of the rocker drive lever 150, in turn, causes the drive pin 222, which is carried by the rocker drive lever 150, into engagement with the groove 246 of the drive bar 102. During the pivoting action, the rocker drive lever 150 works against the spring 214, and the return spring 272 maintains the drive bar 102 in its initial position (up).

As shown in FIG. 6C, while the drive pin 222 is still engaged with the groove 246 of the drive bar 102, the drive frame 162 rotates via the second motor of the motor assembly. By way of example, the drive frame 162 may rotate up to 30 degrees. The cam shaft 161 rotates synchronously with the drive frame 162 thereby keeping the cam lobe 168 positioned against the cam follower 220. By way of example, if the drive frame 162 rotates 30 degrees then the cam shaft rotates 30 degrees. The rocker drive lever 150 also rotates along with the drive frame 162 thereby forcing the drive pin 222 against the groove 246 of the drive bar 102. The force of the drive pin 222 against the groove 246 causes the drive bar 102 to move along its linear path (up and down motion). By way of example, the drive bar 102 may be translated up to about 9 mm. During the linear action, the drive bar 102 works against the return spring 272, and the linear bearings 242 of the bearing module 138 to which the drive bar 102 is attached provides linear guidance to the drive bar 102.

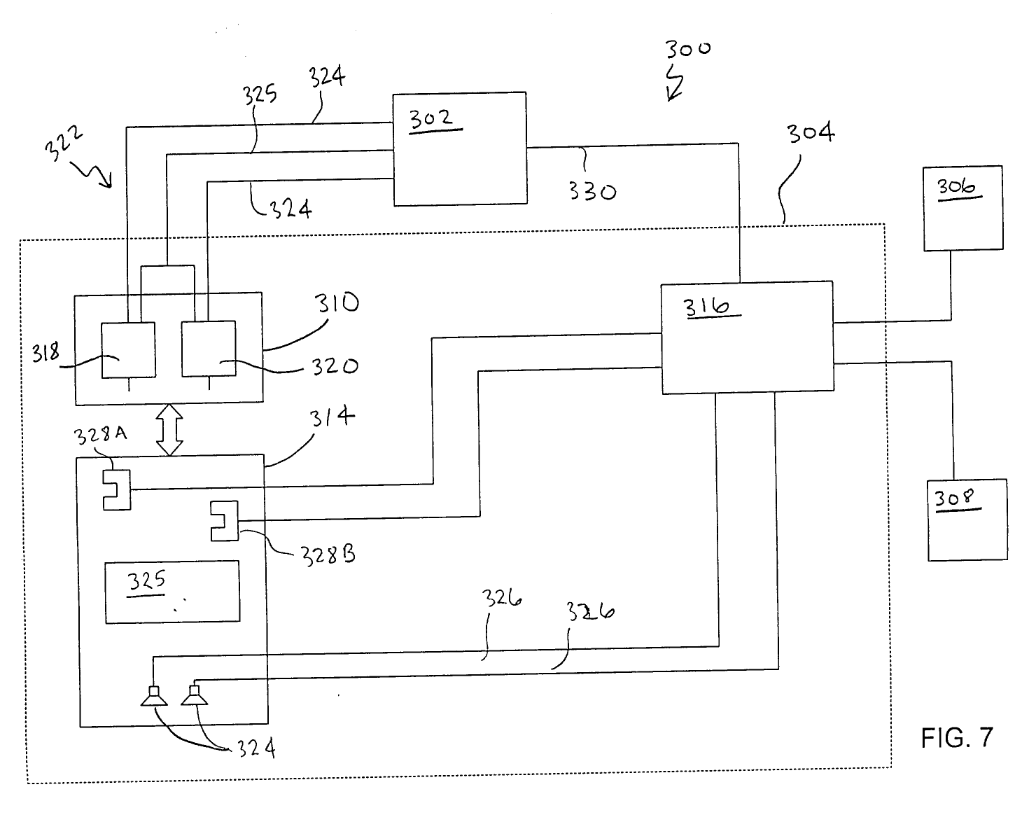

FIG. 7 is a block diagram of a pickhead system 300, in accordance with one embodiment of the present invention. The pickhead system 300 includes a control assembly 302, a pickhead assembly 304, a vacuum source 306 and a pressurized air source 308. As shown, the control assembly 302, the vacuum source 306 and the pressurized air source 308 are all operatively coupled to the pickhead assembly 304. The vacuum source 306 is configured to supply a vacuum to the pickhead system 300 and the pressurized air source 308 is configured to supply pressurized air to the pickhead system 300. The control assembly 302, on the other hand, is configured to control the operation of the pickhead system 300. For example, the control assembly 302 may be arranged to act as a master controller of the pickhead system 300, i.e., commands may be issued to and status may be monitored from the various components of the pickhead assembly 304 so as to facilitate completion of assigned tasks. The control assembly 302 may be widely varied. By way of example, the control assembly 302 may be an embedded or host computer such as a general purpose computer (e.g., PC) or a programmable logic controller. The control assembly 302 may include software for providing inputs and reading outputs from the pickhead system 300. The control assembly 302 may also include software for providing a user interface. By way of example, the user interface may be viewed on a display screen as part of a GUI interface. In cases such as these, the user interface may include a control panel pertaining to one or more events of the pickhead system 300.

The pickhead assembly 304 is generally configured to pick and place parts. By way of example, the pickhead assembly 304 may generally correspond to the pickhead assembly described in FIGS. 1-6. As shown, the pickhead assembly 304 includes a motor assembly 310 (which may correspond to motor assembly 134), a drive mechanism 314 (which may correspond to the cam and drive assemblies 136, 130) and a manifold assembly 316 (which may correspond to manifold assembly 132).

The motor assembly 310 is generally includes one or more motors that provide the driving inputs (e.g., rotational) to the drive mechanism 314. The motors and motor assembly may be widely varied. For example, various motors in various combinations and numbers may be used. In the illustrated embodiment, the motor assembly includes first and second servomotors 318 and 320. Each of the servomotors 318 and 320 are operatively coupled to the control assembly 302. By way of example, the motors may be coupled to the control assembly through a transmission line 322. The transmission line 322 may provide feedback components 324 for receiving and sending inputs and outputs to and from the motors 318 and 320 and control assembly 302, as well as power components 323 for powering the motors 318 and 320. Although, the motors 318 and 320 are shown side by side, it should be noted that this is done for illustration purposes only since the position of the motors may vary according to the needs of each motor assembly 310. In one particular embodiment, each of the motors provides concentric inputs. For example, the motors may be concentrically positioned at the same end (as described previously), or they may be concentrically positioned at opposite ends (e.g., facing each other). Alternatively, the motors be offset from each other (not concentrically positioned relative to the other) with one or both using belts or gears to provide the concentric inputs.

The drive mechanism 314 generally includes components 325 (e.g., drive bars, cams) for moving one or more pick devices 324 (e.g., suction cups), i.e., they transfer the motion of the motors to the pick devices 324. In most cases, the pick devices 324 are attached to drive bars (not shown). Although not a requirement, the drive bars typically move linearly in order to move the one or more pick devices 324. As shown, each of the pick devices 324 is operatively coupled to the manifold assembly 316. For example, in the case of suction cups, the pick devices 324 may be attached to the manifold assembly 316 through hoses or tubes 326, which are capable of transferring vacuum and/or pressurized air. The drive mechanism 314 also includes a sensor arrangement 328 for detecting certain attributes of the pickhead system 300. For example, the sensor arrangement may include a first home sensor 328A for sensing the home position of the first motor 318 and a second home sensor 328B for sensing the home position of the second motor 320. Each of the sensors 328 are operatively coupled to the control assembly 302. The sensors 328 may be coupled to the control assembly 302 directly or indirectly through the manifold assembly 316 as shown.

The manifold assembly 316 is a highly integrated device that integrates sensors, valves, A/D conversion and communications, as well as other features therein. For example, the manifold assembly 316 may include valves for controlling the vacuum or pressurized air flow from the vacuum and pressurized air sources 306, 308 so that the desired amount of flow may be passed through the hose(s) 326 to the pickhead devices 324. The manifold assembly 316 may also include connectors for receiving inputs from the sensors 328 so that the information may be passed to the control assembly 302. As shown, the manifold assembly 316 is operatively coupled to the control assembly 302. The manifold assembly 316 is typically coupled to the control assembly 302 via a communication link through a communication line 330 so that the control assembly 302 and manifold assembly 316 can communicate, i.e., control signals from the control assembly 302 may be passed to the manifold assembly 316 and monitoring signals from the manifold assembly 316 may be passed to the control assembly 302. For example, the control assembly 302 may inform the manifold assembly 316 to supply vacuum to one or more of the pickhead devices 324.

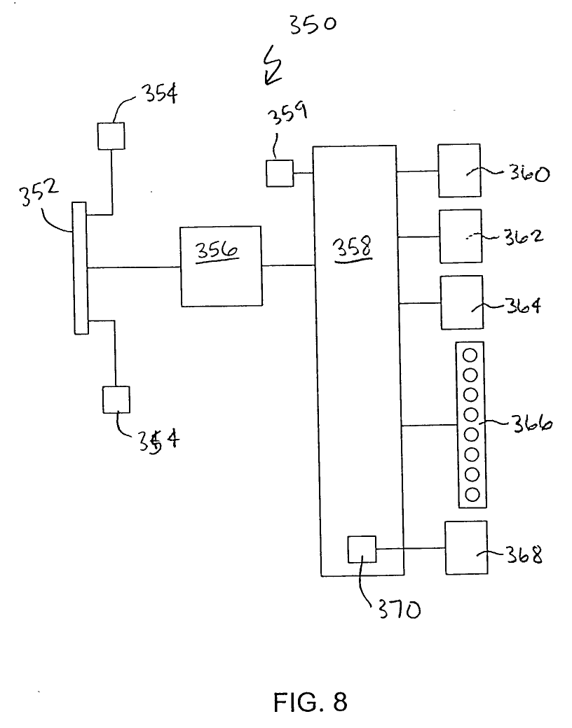

FIG. 8 is a block diagram of a manifold assembly 350, in accordance with one embodiment of the present invention. By way of example, the manifold assembly 350 may generally correspond to the manifold assembly 316 described in FIG. 7. The manifold assembly 350 illustrated in FIG. 8 includes a main I/O connector 352, one or more feed through connectors 354, a communication controller 356, a microcontroller 358 (CPU), one or more vacuum valves 360, one or more miscellaneous inputs 362, one or more miscellaneous outputs 364, an LED array 366, and one or more analog vacuum sensors 368. The main I/O connector 352 is configured to receive a communication line so that the manifold assembly may be connected to a control system. By way of example, the main I/O connector 352 may be a 100 mil pitch header or a 15 pin Dsub connector. The feed through connectors 354 are coupled to the main I/O connector 352. The feed through connectors 354 are generally configured to pass information from an external source to the main I/O connector 352. By way of example, the feedthrough connectors 354 may be configured to receive information from sensors such as home sensors.

The communication controller 356 is also coupled to the main I/O connector 352. The communication controller 356 is configured to process information associated with a high speed communication link, i.e., convert communication protocol information to digital information. By way of example, the communication controller 356 may be capable of processing information associated with universal serial bus (USB), Firewire, RS485, ALINK and the like. The microcontroller 358 is coupled to the communication controller 356, i.e., the microcontroller 358 receives and supplies digital information to and from the communication controller 356. The microcontroller 358 is generally a general purpose digital processor which controls the operation of the manifold assembly 350. The microcontroller 358 can be a single-chip processor or can be implemented with multiple components. By way of example, the microcontroller may be Motorola 8051 microcontroller core manufactured by Motorola of Schaumburg, Ill.

Furthermore, using instructions retrieved from memory 359, the microcontroller 358 may control the reception and manipulation of input and output data. As should be appreciated, the memory 359 can be used to store instructions or program code followed by the microcontroller 358 as well as other data. For example, the microcontroller 358 together with an operating system located on memory 359 may operate to execute computer code and produce and use data. By way of example, the memory may correspond to non volatile memory such as EEPROM.

The microcontroller 358 is coupled to the one or more valves 360, one or more miscellaneous inputs 362, one or more miscellaneous outputs 364, an LED array 366, and one or more analog vacuum sensors 368. The valves are configured to be coupled to a gas source (e.g., vacuum, pressurized air). The valves 360 are also configured to adjust the flow of gases from the gas source under the control of the microcontroller 358. The number of valves typically corresponds to the number of pickhead devices used in the pickhead assembly in which the manifold assembly is placed. It should be noted, however, that this is not a limitation. The miscellaneous inputs 362 and outputs 364 provide additional inputs and outputs in case the manifold assembly 350 needs to be expanded to provide additional functionalities. The LED array 366 is a row of lights that indicates the status of various components of the manifold assembly 350 under the control of the microcontroller 358. By way of example, the LED array 366 may be used to indicate when the valves 360 are activated. The analog vacuum sensors 368 are configured to detect the amount of vacuum through the valves 360. The analog vacuum sensors are generally coupled to the microcontroller 358 through an analog to digital converter 370 (A/D converter).

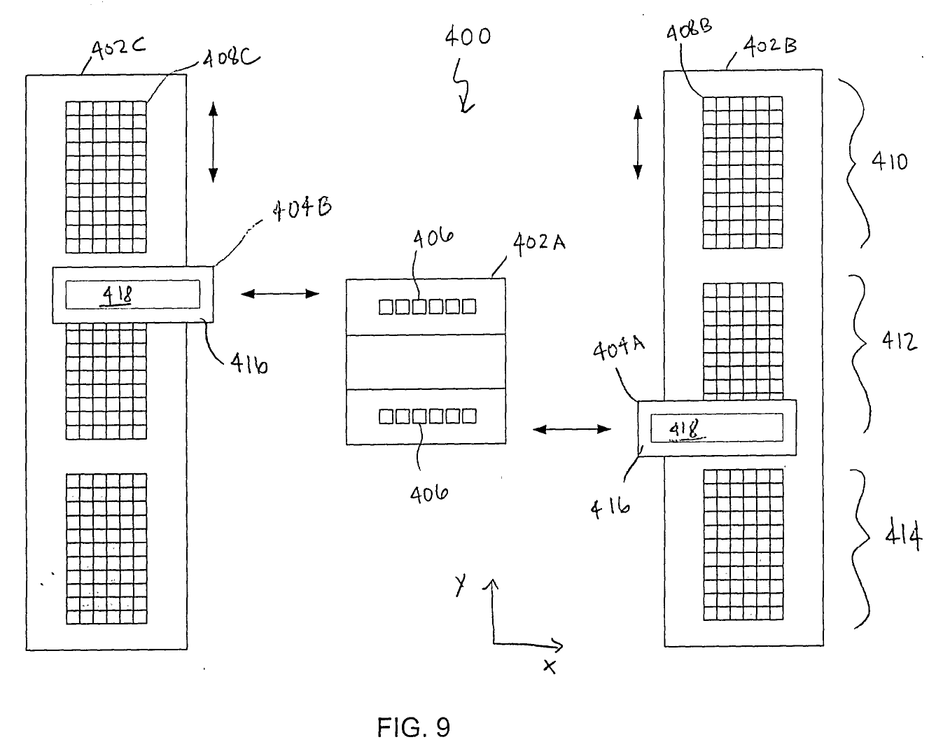

FIG. 9 is a simplified diagram of an integrated circuit processing system 400, in accordance with one embodiment of the present invention. The integrated circuit processing system 400 includes at least a pair of work stations 402 A and B and a pick and place machine 404A. The workstations 402 are generally configured to process parts such as integrated circuit chips 406. By way of example, the workstations 402 A and B may be buffering, singulating, cleaning (e.g., wash and dry), testing (e.g., electrical), inspecting (e.g., vision), packaging, transfering, outputting stations, and/or the like. The pick and place machine 404A, on the other hand, is generally configured to transport parts such as integrated circuit chips 406 from the first workstation 402A to the second workstation 402B.

The number of workstations and pick and place machines may be widely varied. For example, the integrated circuit processing system 400 may also include two or more workstations and one or more pick and place machines. For example, the integrated circuit processing system 400 may include a third workstation 402C and a second pick and place machine 404B. The second pick and place machine 404B typically functions similarly to the first pick and place machine 404A. As should be appreciated, increasing the number of pick and place machines allows more chips to be transported, i.e., the number of chips transported may be maximized thus increasing throughput.

In the illustrated embodiment, the first workstation 402A corresponds a buffer station for buffering processed chips. By way of example, buffer station may be part of a singulation machine configured to dice a substrate into a plurality of chips. The singulation machine may also be configured to clean and inspect the chips after singulation. A representative singulation machine may be found in co-pending patent application Ser. No. ______ (Attorney Docket No. ICONP004) filed on same day and which is herein incorporated by reference.

The second and third workstations 402B and 402C, on the other hand, correspond to output stations. In particular, the second workstation 402B corresponds to a good chip output station and the third workstation 402C corresponds to a reject or bad chip output station. In either case, the output stations generally include output trays 408 within which the singulated chips 406 may be placed. The output trays 408 may be used to further transport the chips 406 to other stations or they may be used to transport the chips 406 to customers. As should be appreciated, chips are generally visually, electrically or electronically inspected to determine good or rejects after a singulation procedure. Chips that test good, are placed in the good trays 408B and chips that test bad are placed in the reject trays 408C. The trays 408 may be moved in multiple directions such as X, Y and Z at various times during processing in order to continuously load chips onto the trays. As shown in FIG. 9, the trays 408 are configured to move in a single direction such as Y. In most cases, the trays 408 are conveyed between a tray input area 410 (e.g., empty trays), a chip loading area 412 and a tray output area 414 (e.g., full trays).

To elaborate, the pick and place machines 404 A and B generally include a transfer mechanism 416 and one or more pickhead assemblies 418. The transfer mechanism 416 is configured to move the pickhead assembly 418 between the workstations 402 A-C and the pickhead 418 is configured to pick and place the chips 406. By way of example, the pick head assembly 418 may be the high speed pickhead described in FIGS. 1-6. The transfer mechanism 416 may be configured to move the pickhead in multiple directions such as the X, Y and/or Z directions (e.g., horizontal). In the illustrated embodiment, however, the transfer mechanism 416 is configured to move in the X direction. Although not shown, the pickhead assembly 418 generally includes one or more pickheads, each of which is configured to pick and place a chip, i.e., with a pick device such a suction cup. As should be appreciated, the pickhead 418 typically moves in the Z direction (into and out of the page) in order to pick and place the integrated circuit chips 406. In one particular implementation, the pickhead assembly 418 includes eight pickheads.

In one implementation, the singulated chips 406 are picked up at the same time. For instance, the transfer unit 416 moves over a row of chips (e.g., eight) and the pickheads of the pickhead assembly 418 move down, each engaging one of the chips 406 in the row. Once engaged, the pick device of each of the pickheads grabs the corresponding chip in the row and thereafter the pickheads move up. In another rimplementation, the singulated chips 406 are picked up at different times. For instance, the transfer mechanism 416 moves over a row of chips and a first pickhead moves down and engages one of the chips in the row. Once engaged, the pick device of the pickhead grabs the chip and thereafter the pickhead moves up. Once retracted, the transfer mechanism 416 steps the pickhead assembly 418 over the next chip and a second pickhead moves down and engages another chip in the row. Once engaged, the pick device of the second pickhead grabs the chip and thereafter the second pickhead moves up. This continues until the entire row of chips (or a portion thereof) are picked up by the pickhead assembly 418. Picking at different times is generally done when the size of the chips do not coincide with the pitch of the pickheads (e.g., spacing between the pickheads). That is, if the size of the chips do not coincide with the pitch of the pickheads, then the pickheads may move separately between steps by the transfer mechanism 416 in order to pick up the chips 406. In a similar manner, the picked chips may be placed at the same time or they may be placed at different times.

Furthermore, the chips may be picked or placed sequentially or they may be picked or placed randomly. If in a sequence, then the first pickhead picks (or places), thereafter the second pickhead picks, thereafter a third pickhead picks, and so on. If random, then the pickheads can move in any order. For example, a fourth pickhead may pick (or place), thereafter the first pickhead may pick, thereafter an eigth pickhead may pick, and so on. Random picking and placing allows the pick and place machines 404 to place all the good chips when at the good tray and to place all the reject chips when at the reject tray. This save time, i.e., the transfer unit does not have to go back and forth between the good and reject tray as in sequential placing.

The advantages of the invention are numerous. Different embodiments or implementations may have one or more of the following advantages. One advantage of the invention is that it has the ability to pick or place eight parts at a time at a maximum rate of 30,000 units per hour. Another advantage of the invention is that it provides sequential or random selection. Another advantage of the invention is that it provides complete programmable control of position, speed, acceleration, and sensor trip points. Another advantage of the invention is that it is highly integrated, combining mechanism, pneumatic control, and electronics in a very compact package measuring 3.5×3.5×11 inches and weighing less than 5 pounds.

While this invention has been described in terms of several preferred embodiments, there are alterations, permutations, and equivalents, which fall within the scope of this invention. For example, although the drive bar of the pickhead assembly has been described as moving in a linear manner, by way of rotary to linear conversion, it should be noted that this is not a limitation. The drive bar may be configured to move in a rotary manner or any other manner which could be imagined or applied. It should also be noted that there are many alternative ways of implementing the methods and apparatuses of the present invention. For example, it is also possible for the pickhead to move integrated circuits before singulation, i.e., while they are still attached on a substrate. This generally depends on the type and the size of the substrate and configuration of the pickhead. IN addition, although the high speed pickhead has been described in context of moving integrated circuits, it should be noted that the high speed pickhead may be used to move any discrete parts. For example, the high speed pickhead may be used to move other types of electrical components such as resistors, transistors, capacitors and the like. The high speed pickhead may also be used to move biotechnological devices, optical devices, opto-electrical devices, electro-mechanical devices (e.g., MEMS-micro electro-mechanical) or the like. It is therefore intended that the following appended claims be interpreted as including all such alterations, permutations, and equivalents as fall within the true spirit and scope of the present invention.

What is claimed is:

1. A pickhead apparatus having a plurality of pickheads for picking and placing parts, each of the pickheads including a drive bar and a pick device, the drive bar being configured to move in a linear manner, the pick device being configured to grip or release a discrete part, the pickhead assembly comprising:
a single actuator capable of providing motion for moving the plurality of drive bars; and
a drive mechanism configured to transmit the motion of the single actuator to a selected drive bar of the plurality of drive bars so as to move the selected drive bar along a linear path.

2. The pickhead apparatus as recited in claim 1 wherein the single actuator is capable of providing rotary motion, and wherein the drive mechanism converts the rotary motion into linear motion so as to move the selected drive bar along the linear path.

3. The pickhead apparatus as recited in claim 1 wherein the single actuator is a motor.

4. The pickhead apparatus as recited in claim 3 wherein the motor is a servomotor.

5. The pickhead apparatus as recited in claim 1 further including a selection mechanism configured to select one of the drive bars.

6. The pickhead apparatus as recited in claim 5 wherein the selection mechanism includes a cam arrangement that is controlled by a second single actuator.

7. The pickhead apparatus as recited in claim 5 wherein the second single actuator is capable of providing rotary motion, the rotary motion being used to rotate the cam arrangement so that cam arrangement causes the selection of a specific drive bar.

8. A pickhead assembly having a plurality of pickheads for picking and placing parts, the pickhead assembly comprising:
a cam assembly capable of moving so as to select a particular pickhead and to drive the particular pickhead along a linear path; and
an actuator assembly operatively coupled to the cam assembly, the actuator assembly being configured to control the movement of the cam assembly so as to select and drive the particular pickhead.

9. The pickhead apparatus as recited in claim 8 wherein the actuator assembly comprises:
a first motor for controlling a first movement of the cam assembly, the first movement being associated with selecting the particular pickhead; and
a second motor for controlling a second movement of the cam assembly, the second movement being associated with driving the particular pickhead along the linear path.

10. The pickhead apparatus as recited in claim 9 wherein the first and second motors are combined into a single unit.

11. The pickhead apparatus as recited in claim 9 wherein the first and second motors are servomotors.

12. The pickhead apparatus as recited in claim 8 wherein the cam assembly comprises:
a cam arrangement for selecting the particular pickhead; and
a drive mechanism for driving the particular pickhead along the linear path.

13. The pickhead apparatus as recited in claim 12 wherein the cam arrangement includes a rotatable cam shaft having a plurality of cam plates, the number of cam plates corresponding to the number of pickheads, each of the cam plates being configured to cause the selection of a different pickhead, and wherein the drive mechanism includes a rotatable drive frame configured to engage the particular pickhead so as to move the particular pickhead along the linear path.

14. The pickhead apparatus as recited in claim 13 wherein the cam shaft is coupled to a first servomotor of the actuator assembly, and wherein the drive frame is coupled to a second servomotor of the actuator assembly.

15. A pickhead apparatus capable of picking and placing integrated circuits, comprising:
a drive bar assembly including one or more drive bars that move in a linear manner;
a motor assembly including a first servomotor and a second servomotor;
a cam assembly operatively coupled to and between the drive bar and motor assemblies, the cam assembly including a cam arrangement that is actuated by the first servomotor so as to select a particular drive bar of the drive bar assembly, and a drive frame that is actuated by the second servomotor so as to drive the particular drive bar when selected by the cam arrangement.

16. The apparatus as recited in claim 15 wherein the first and second servomotors are combined into a single unit having a single housing.

17. The apparatus as recited in claim 16 wherein the single unit is a dual concentric servomotor having first and second drive shafts that are concentrically positioned and that rotate about the same axis.

18. The apparatus as recited in claim 15 wherein the cam assembly includes a cam shaft that moves relative to and that is concentrically located within a drive frame, the cam shaft being operatively coupled to the first servomotor and the drive frame being operatively coupled to the second servomotor.

19. The apparatus as recited in claim 18 wherein the drive frame rotatebly supports the cam shaft inside the drive frame

20. The apparatus as recited in claim 18 wherein the cam shaft has one or more cam plates that correspond to the one or more drive bars.

21. The apparatus as recited in claim 18 wherein the cam assembly further includes a rocker drive lever assembly that cooperates with the cam arrangement to select a particular drive bar, and that cooperates with the drive frame to drive the drive bars along the linear path.

22. The apparatus as recited in claim 21 wherein the rocker drive lever assembly includes one or more rocker drive levers that pivot relative to the drive frame, each of the rocker drive levers being operatively coupled to individual ones of the drive bars and individual ones of the cam plates, each of the rocker levers including a cam follower capable of engaging a corresponding cam plate and a drive pin capable of engaging a corresponding drive bar, the cam follower being configured to transmit the motion of the cam shaft to the rocker lever so as to secure the drive pin to the drive bar, the secured drive pin being configured to transmit the rotary motion of the drive frame to the drive bar so as to move the drive bar in the linear manner.

23. A pickhead apparatus capable of picking and placing integrated circuits, comprising:
a drive bar assembly including one or more drive bars that move in a linear manner, each of the drive bars having a pick device attached thereto, each of the pick devices being configured to grip or release an integrated circuit;
a movement assembly for moving the one or more drive bars between a retracted position and an extended position, the extended position placing the pick device in a position to grip or release an integrated circuit;
a manifold assembly that integrates a plurality of control components associated with controlling the movement assembly and the pick devices, the manifold assembly including at least a circuit board having communication and analog to digital conversion capabilities.

24. The apparatus as recited in claim 23 wherein the circuit board is a analog to digital conversion circuit board.

25. The apparatus as recited in claim 23 wherein the circuit board has a communication link.

26. The apparatus as recited in claim 25 wherein the communication link is selected from RS485, ALINK, USB, or Firewire.

27. The apparatus as recited in claim 23 wherein the pick device is a suction cup.

28. The apparatus as recited in claim 23 wherein the manifold assembly further includes a manifold having fittings and couplings attached thereto, the number of fittings corresponding to the number of pick devices, each of the fittings being configured to receive an individual air hose for coupling to an individual pick device, the couplings being configured to be coupled to at least a vacuum source and a pressurized air source, the manifold also having a plurality of valves for controlling the vacuum or air flow through the fittings and couplings, and a plurality of sensors for measuring the pressure of the flow through valves, the plurality of sensors being operatively coupled to the circuit board

29. The apparatus as recited in claim 28 wherein the sensors are pressure transducers and wherein the sensors are connected to the circuit board through a plurality of connectors.

30. The apparatus as recited in claim 28 wherein the circuit board includes a connector for receiving and transmitting data to and from the circuit board and wherein the circuit board includes an LED array which relays the status information associated with the pickhead apparatus to a user.

31. A pickhead apparatus having one or more drive bars that move in a linear manner, each of the drives bars having one or more pick devices attached thereto, the pickhead apparatus comprising;
a dual concentric servomotor having first and second drive shafts that are concentrically positioned and that rotate about the same axis;
a drive assembly including a cam shaft that moves relative to and that is concentrically located within a drive frame, the cam shaft being coupled to the first drive shaft and the drive frame being coupled to the second drive shaft such that they both rotate about the same axis, the cam shaft having one or more cam plates that correspond to the one or more drive bars, the drive frame having one or more rocker levers that pivot relative to the drive frame, each of the rocker levers being operatively coupled to individual ones of the drive bars and individual ones of the cam plates, each of the rocker levers including a cam follower capable of engaging a corresponding cam plate and a drive pin capable of engaging a corresponding drive bar, the cam follower being configured to transmit the motion of the cam shaft to the rocker lever so as to secure the drive pin to the drive bar, the secured drive pin being configured to transmit the rotary motion of the drive frame to the drive bar so as to move the drive bar in the linear manner.

32. A method of picking or placing parts with a plurality of pickheads, the motion of each of the pickheads being controlled by a single source, the method comprising:
selecting one of the pickheads;
controlling the linear movement of the selected pickhead with the single source;
selecting another one of the pickheads; and
controlling the linear movement of the second selected pickhead with the single source.

33. A pickhead apparatus capable of randomly picking or placing a plurality of integrated circuits in any order.

34. A pickhead apparatus capable of converting rotary motion into linear motion so as move a drive bar having a pick device attached thereto.

35. A pickhead apparatus capable of driving a plurality of pickheads with a single driving source, the pickheads being configured to pick and place integrated circuits.
